(19) United States
(12) Patent Application Publication
(10) Pub. No.: US 2019/0238903 A1
(43) Pub. Date: Aug. 1, 2019

(54) NETWORK BROADCASTING SYSTEM AND METHOD

(71) Applicant: Reachme.TV Inc., Los Angeles, CA (US)

(72) Inventor: Ron Bloom, Los Angeles, CA (US)

(21) Appl. No.: 15/885,786

(22) Filed: Jan. 31, 2018

(51) Int. Cl. H04N 21/2387; H04N 21/414; H04N 21/472; H04N 21/84

(52) U.S. Cl. CPC H04N 21/2387; H04N 21/41407; H04N 21/23106; H04N 21/84; H04N 21/47217

(57) ABSTRACT

Network broadcasting systems for broadcasting and distributing digital video content to multiple displays or devices over a network, caching digital video content on those displays or devices, controlling the program scheduling on those displays or devices, remotely administering the displays or devices over the network, and methods for using the same are presented. The methods and systems of the present invention may be used to provide a television network with one or more television channels that may be viewed on television displays installed at fixed locations. The television channels may alternatively be viewed on a mobile device. The method of the present invention includes time synchronization of the one or more television channels across multiple displays and devices so that, for example, a viewer watching a television program on a television at a fixed location may leave the area and continue viewing the same program on their mobile device.

### BACKGROUND OF THE INVENTION

### (1) Field of the Invention

The present invention relates generally to digital video broadcasting, distribution, storage, program scheduling, and playback, and more particularly to network broadcasting systems and methods for distributing digital video content to multiple displays or devices over a computer network, caching digital video content on those displays or devices, controlling the program scheduling on those displays or devices, remotely administering the displays or devices over the network, and methods for using the same.

### (2) Description of the Related Art

Publicly-viewable broadcast television or video displays are commonly featured in locations such as airports, hotels, restaurants, bars, retail stores, and plazas, among others. Every such television or video display requires a video source, such as over-the-air broadcast television signals, a cable or satellite television service, or video data transmitted via a local computer network or the Internet.

Locations with many displays often have specialized systems and infrastructure for distributing video content to the several displays from a central location. For example, a prior art video distribution system used at an airport may include multiple video sources, such as a cable television signal, locally-generated flight arrival/departure and airport information graphics, and video or still-image advertisements. These video sources may be routed through one or more video switchers and/or video distribution amplifiers to multiple displays throughout the airport. In locations where multiple displays are visible at once, a matrix switcher may be used to route different video signals to each display so that, for example, one display may show a cable news channel while an adjacent display may show arrival/departure information.

Other examples of prior art video distribution systems include digital signage systems such as TargetR and Convergent, which use embedded computer systems installed at or near each display to show video or still image content streamed via a local computer network or the Internet.

Prior art digital video distribution and digital signage systems are limited in their ability to store, organize, and distribute large volumes of content, such as a television network's catalogue of shows and advertisements. Such prior art systems do not provide methods for organizing the content in a hierarchical or relational fashion to facilitate locating, scheduling, and playing the content. Further, prior art systems provide limited data tracking, reporting, and analytics functionality to measure viewership of shows and advertisements.

### BRIEF SUMMARY OF THE INVENTION

Systems for broadcasting digital video content to multiple displays or devices over a network, caching digital video content on those displays or devices, controlling the program scheduling on those displays or devices, remotely administering the displays or devices over the network, and methods for using the same are presented. In one or more embodiments, the system of the present invention includes one or more television displays, each display having a video playback device (e.g., an embedded computer device connected to the display, or alternatively, a “smart TV” with an integrated embedded computer system), one or more mobile devices, a wireless or wired computer network, and one or more server computer systems.

In one or more embodiments, the method of the present invention may be used to provide a television network with one or more television channels that may be viewed on television displays installed at fixed locations, such as airports, hotels, restaurants, bars, retail stores, plazas, and other places where television may be viewed by members of the public. In one or more embodiments, the television channels may alternatively be viewed on a mobile device, such as a smartphone, tablet computer, laptop computer, or similar device. In one or more embodiments, the method of the present invention includes time synchronization of the one or more television channels across multiple displays and devices so that, for example, a viewer watching a television program on a television at an airport may leave the area and continue viewing the same program on their mobile device.

In one or more embodiments, the method of the present invention includes the selection and ordering of multiple items of digital video content, pictures, or text (“segments”) into a sequence. In one or more embodiments, sequences may be nested, i.e., one sequence may itself be treated as a segment that is ordered in another sequence. In one or more embodiments, a sequence of segments may be transferred to one or more video playback devices for playback either immediately or at a later time.

In one or more embodiments, the method of the present invention includes defining the layout and positioning of segments and/or sequences on the display screen. In one or more embodiments, a “main program” is displayed on screen and is surrounded on one or more edges by “sidebars” that display additional video content, pictures, or text. In one or more embodiments, a list of segments and/or sequences is displayed alongside the main program (for example, as thumbnail images) to show a preview of upcoming programs.

In one or more embodiments, the method of the present invention includes the creation, display, and tracking of advertising segments. An advertising segment may be digital video content, pictures, text, or a combination thereof. Advertising segments may be included in a sequence, optionally along with other types of segments and/or sequences. In one or more embodiments, the method of the present invention includes models for computing or estimating the number of viewers who are likely to have seen an advertising segment. For example, in an airport, the number of passengers arriving and departing at particular times is known, and may be used as a heuristic to estimate the number of passengers who may have viewed the advertising segment on a display at the airport.

### BRIEF DESCRIPTION OF THE DRAWINGS

The present invention may be better understood, and its features made apparent to those skilled in the art by referencing the accompanying drawings.

FIG. 1 is a block diagram of a system for distributing digital video content to multiple displays according to an embodiment of the present invention.

FIG. 2 is a block diagram of a system for distributing digital video content to multiple displays and mobile devices according to an embodiment of the present invention.

FIG. 3 is a block diagram of a method for the selection and ordering of multiple items of digital content into a sequence according to an embodiment of the present invention.

FIG. 4 shows the layout and positioning of content on a display according to an embodiment of the present invention.

FIG. 5 shows the layout and positioning of content on a web page according to an embodiment of the present invention.

FIG. 6 is a flow chart illustrating the method steps to load and play back a sequence on a display according to an embodiment of the present invention.

FIG. 7 is a flow chart illustrating the method steps to load and play back a sequence on a web page according to an embodiment of the present invention.

FIG. 8 is a block diagram of the components used to display digital video content on a web page according to an embodiment of the present invention.

FIG. 9 is a block diagram of an advertisement campaign manager used to select, display, and estimate viewership of advertisements according to an embodiment of the present invention.

FIG. 10 is a block diagram of an advertisement campaign reporter used to track and report estimated viewership of advertisements according to an embodiment of the present invention.

### DETAILED DESCRIPTION OF THE INVENTION

Systems for broadcasting digital video content to multiple displays or devices over a network, caching digital video content on those displays or devices, controlling the program scheduling on those displays or devices, remotely administering the displays or devices over the network, and methods for using the same are presented. In one or more embodiments, the system of the present invention includes one or more television displays, each display having a video playback device (e.g., an embedded computer device connected to the display, or alternatively, a “smart TV” with an integrated embedded computer system), one or more mobile devices, a wireless or wired computer network, and one or more server computer systems.

In one or more embodiments, the method of the present invention may be used to provide a television network with one or more television channels that may be viewed on television displays installed at fixed locations, such as airports, hotels, restaurants, bars, retail stores, plazas, and other places where television may be viewed by members of the public. In one or more embodiments, the television channels may alternatively be viewed on a mobile device, such as a smartphone, tablet computer, laptop computer, or similar device. In one or more embodiments, the method of the present invention includes time synchronization of the one or more television channels across multiple displays and devices so that, for example, a viewer watching a television program on a television at an airport may leave the area and continue viewing the same program on their mobile device.

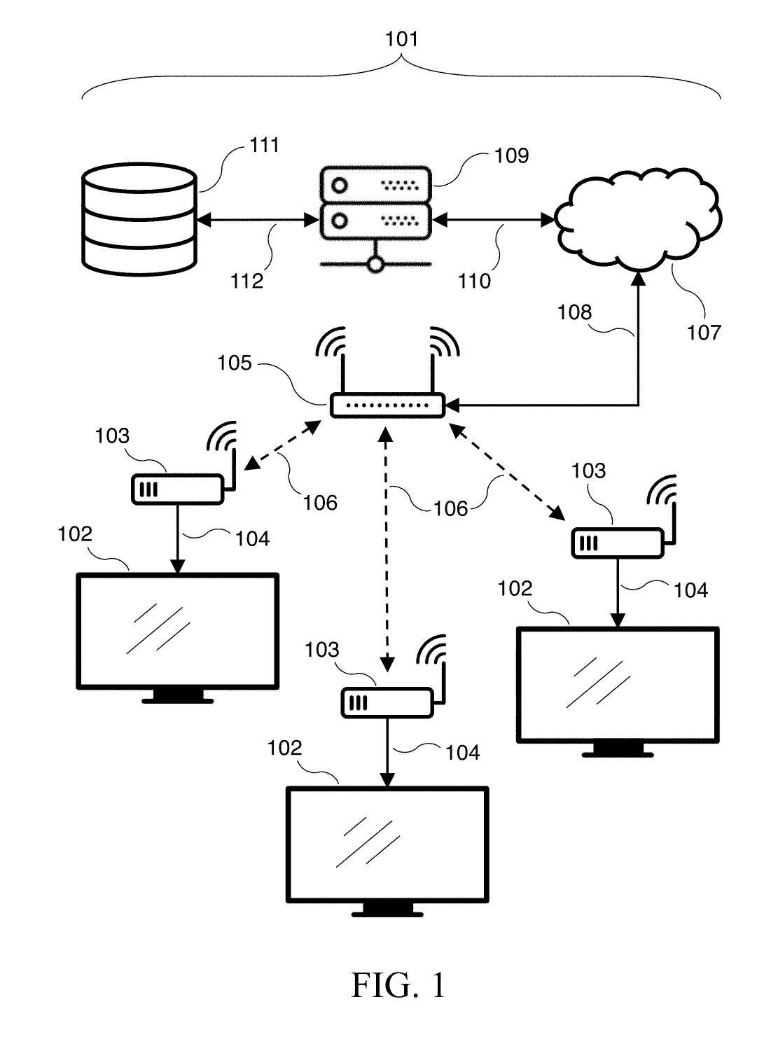

FIG. 1 is a block diagram of a system 101 for distributing digital video content to multiple displays 102 according to an embodiment of the present invention. In the embodiment of FIG. 1, system 101 comprises displays 102, video playback devices 103, network access point 105, the Internet 107, server computer system 109, and database 111. In one or more embodiments, display 102 may be a television or a monitor.

In the embodiment of FIG. 1, video playback device 103 comprises an embedded computer system with a microprocessor and memory, a wireless or wired network interface, and an audio/video output. In one or more embodiments, the embedded computer system of video playback device 103 is a commercially available embedded computer system, such as the computer systems manufactured by MINIX that run the Android operating system. Further information regarding the MINIX computer systems can be found at http://minix.com.hk/, all of which is incorporated herein by reference. Alternatively, in one or more embodiments, the embedded computer system of video playback device 103 may be any other commercially available embedded computer system, such as a Raspberry Pi device, or may be a Field-Programmable Gate Array (“FPGA”) board, or may be a custom hardware design specifically tailored to provide the functionality of video playback device 103. However, the functionality of video playback device 103 may be provided by any computer system with suitable network and audio/video output hardware, including a conventional desktop or laptop computer, or a tablet computer, mobile phone, or similar device.

In the embodiment of FIG. 1, each video playback device 103 is connected to a display 102 via audio/video connection 104. Audio/video connection 104 may comply with HDMI or DisplayPort interface and signal transport standards, which allow transport of both audio and video data over the same cable, or alternatively or in addition may comply with DVI, VGA, YP_{R}P_{B} component video, S-video, composite video, or any other digital or analog video interface standards in combination with any method of transmitting digital or analog audio data.

In the embodiment of FIG. 1, network access point 105 is a wireless network access point that complies with Wi-Fi network standards. Alternatively, in one or more embodiments, network access point 105 may be a wired Ethernet hub, switch, router, gateway, or similar network equipment. In the embodiment of FIG. 1, each video playback device 103 is connected to network access point 105 via network connection 106. In the embodiment of FIG. 1, network connection 106 is a wireless network connection that complies with Wi-Fi network standards. Alternatively, in one or more embodiments, network connection 106 may be a wired Ethernet connection or any other type of network connection. Note that while a direct wireless network connection 106 is shown between each video playback device 103 and network access point 105 in FIG. 1, network connection 106 may comprise a more complex network topology with multiple wireless network access points and/or wired hubs, switches, routers, gateways, and other network equipment.

In the embodiment of FIG. 1, network access point 105 is connected to the Internet 107 via network connection 108, and the Internet 107 is connected to server computer system 109 via network connection 110. In the embodiment of FIG. 1, network connections 108 and 110 are wired Ethernet connections. Alternatively, in one or more embodiments, either of network connections 108 or 110 may be a wireless network connection that complies with Wi-Fi network standards, or any other type of network connection. Note that while direct wired network connections 108 and 110 are shown between network access point 105, the Internet 107, and server computer system 109 in FIG. 1, either of network connections 108 or 110 may comprise a more complex network topology with multiple wireless network access points and/or wired hubs, switches, routers, gateways, and other network equipment.

In one or more embodiments, database 111 may be a relational database, an object-oriented database, a hierarchical database, a flat file database, a key-value database, or any other type of data storage and retrieval system. In the embodiment of FIG. 1, database 111 is implemented as an application running on a separate computer system from server computer system 109 and database 111 is connected to server computer system 109 via network connection 112. In the embodiment of FIG. 1, network connection 112 is a wired Ethernet connection. Alternatively, in one or more embodiments, network connection 112 may be a wireless network connection that complies with Wi-Fi network standards, or any other type of network connection. Note that while a direct wired network connection 112 is shown between database 111 and server computer system 109 in FIG. 1, network connection 112 may comprise a more complex network topology with multiple wireless network access points and/or wired hubs, switches, routers, gateways, and other network equipment. In one or more embodiments, database 111 may instead be implemented as an application running on the same computer as server computer system 109 and server computer system 109 may communicate with database 111 via an internal network connection, such as a socket connection implemented in software, or via shared memory or storage, or any other method of communication between applications on the same computer system.

In the embodiment of FIG. 1, video playback device 103 is configured to obtain digital video content from server computer system 109 and/or database 111 and play the obtained video content on display 102. In one or more embodiments, video playback device 103 may stream digital video content from server computer system 109 and/or database 111 via the network and play the video content immediately. In one or more embodiments, video playback device 103 may instead transfer one or more items of digital video content from server computer system 109 and/or database 111 and store those items in the memory of video playback device 103 for playback at a later time. In the embodiment of FIG. 1, server computer system 109 is configured to store and retrieve video content (and associated metadata as described below) in and from database 111.

In one or more embodiments, video playback devices 103 are configured to use peer-to-peer data transfer techniques to reduce the computing and network resource demands on server computer system 109 and/or database 111. In one or more embodiments, once a first video playback device 103 has obtained and stored one or more items of digital video content, the first video playback device may advertise itself on the network as having a copy of those items and may serve those items of digital video content to other video playback devices 103 that request copies from the first video playback device 103. In one or more embodiments, video playback devices 103 are configured to retrieve items of digital video content from the fastest or nearest other video playback device 103, server computer system 109, or database 111 as determined by measurements of bandwidth, ping time, or other network performance metrics.

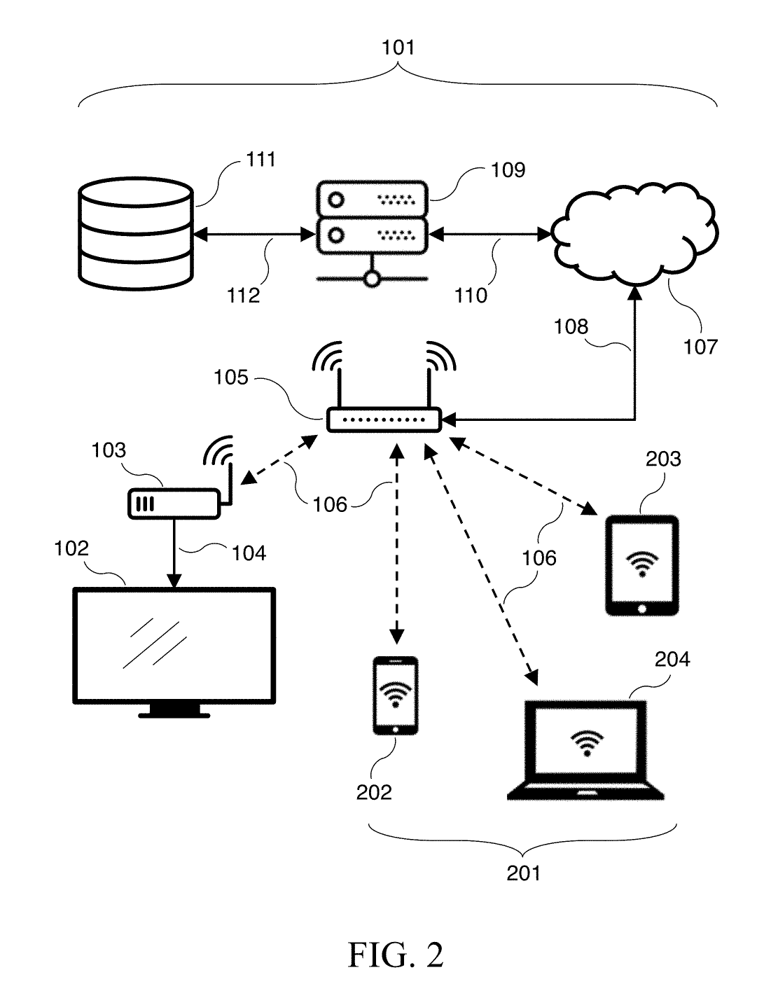

FIG. 2 is a block diagram of a system for distributing digital video content to multiple displays 102 and mobile devices 201 according to an embodiment of the present invention. The configuration of the system in the embodiment of FIG. 2 is similar to the embodiment of FIG. 1, except that in addition to video playback devices 103, one or more mobile devices 201 are connected to network access point 105 via network connections 106. As described above, each network connection 106 may be a wireless or wired network connection or may comprise a more complex network topology. In the embodiment of FIG. 2, mobile devices 201 include mobile phone 202, tablet computer 203, and laptop computer 204, but in one or more embodiments may also include any other device capable of connecting to network access point 105.

In the embodiment of FIG. 2, mobile device 201 is configured to obtain digital video content from server computer system 109 and/or database 111 and play the obtained video content on an integrated display. In one or more embodiments, mobile device 201 may stream digital video content from server computer system 109 and/or database 111 via the network and play the video content immediately. In one or more embodiments, mobile device 201 may instead transfer one or more items of digital video content from server computer system 109 and/or database 111 and store those items in the memory of mobile device 201 for playback at a later time. In one or more embodiments, mobile device 201 is configured to use peer-to-peer data transfer techniques as described above to retrieve items of digital video content from the fastest or nearest video playback device 103, server computer system 109, database 111, or other mobile device 201.

In one or more embodiments, the method of the present invention may be used to provide a television network with one or more television channels that may be viewed on displays 102 installed at fixed locations, such as airports, hotels, restaurants, bars, retail stores, plazas, and other places where television may be viewed by members of the public. In one or more embodiments, the television channels may alternatively be viewed on mobile devices 201. In one or more embodiments, server computer system 109 and/or database 111 are configured to synchronously stream video content to some or all video playback devices 103 and mobile devices 201 so that the same content may be viewed simultaneously on multiple video playback devices 103 and mobile devices 201. In one or more embodiments, if one or more video playback devices 103 and/or mobile devices 201 have previously stored digital video content in memory for playback at a later time, those video playback devices 103 and/or mobile devices 201 are configured to synchronously play the video content with each other and with the streaming video content being played by any other video playback devices 103 and/or mobile devices 201. In one or more embodiments, this playback synchronization allows a viewer watching a television program on a display 102 at a fixed location (for example, an airport gate) to leave the area and continue viewing the same program on their mobile device 201.

In one or more embodiments, the method of the present invention includes remote administration of video playback devices 103 by server computer system 109 or by another computer system over the network. Remote administration of video playback devices 103 includes tasks such as powering the devices off and on, installing updated operating system and/or application software on the devices, sending schedules to the devices, and instructing the devices to immediately play a segment or sequence, and other such tasks.

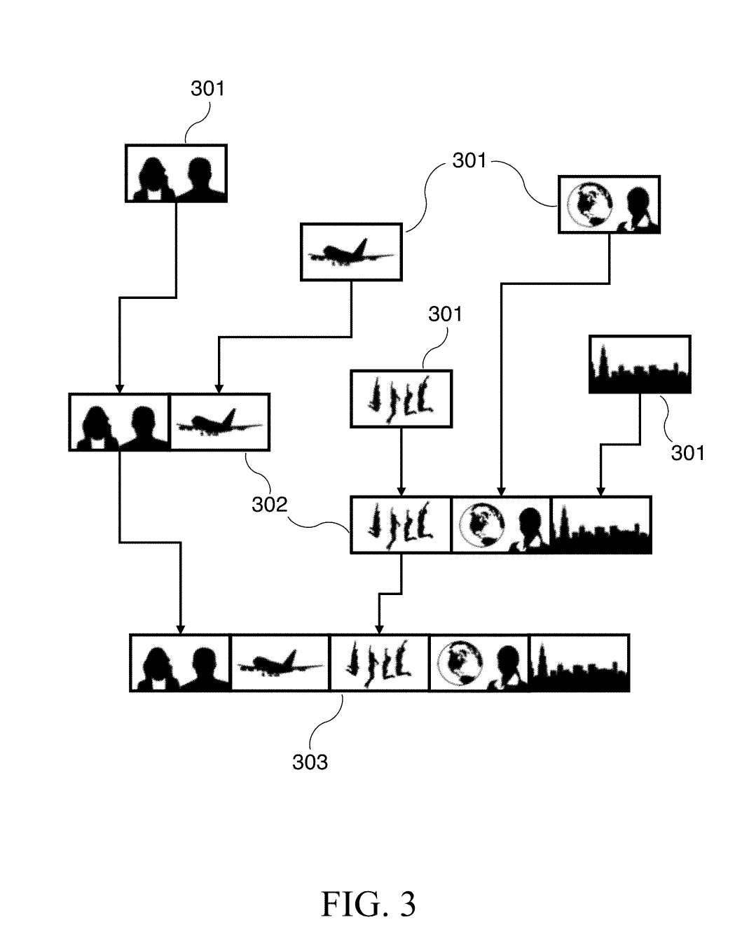

FIG. 3 is a block diagram of a method for the selection and ordering of multiple items of digital video content, pictures, or text (“segments”) 301 into sequences 302 according to an embodiment of the present invention. The method may, for example, be performed on server computer system 109 as part of the remote administration of video playback devices 103.

A sequence 302 is a collection of segments placed in a defined order such that when sequence 302 is played on video playback devices 103 and/or mobile devices 201, each segment 301 of sequence 302 is played one after another. In the embodiment of FIG. 3, sequences 302 may be nested, i.e., one sequence 302 may itself be treated as a segment that is ordered in another sequence 303. In one or more embodiments, server computer system 109 provides a user interface (for example, a web-based user interface accessible by a web browser via the Internet 107) that allows a user to create and edit sequences 302 and 303 by the selection and ordering of segments 301 and to store created and edited sequences 302 and 303 in database 111. In one or more embodiments, sequences 302 and/or 303 may be transferred to one or more video playback devices 103 for playback either immediately or at a later time. In one or more embodiments, a sequence 302 or 303 comprises a sequence of text identifying locations (such as URLs) from which the actual video content of the segments can be obtained by a video playback device 103. In one or more embodiments, a series or group of sequences may be defined to form a “program” of related audio/video content, such as for example a sports or entertainment program, to be played back as part of a group of related programs on a “channel” of content available on video playback device 103.

In one or more embodiments, segments 301 may comprise actual content in the form of video, image, or text files stored in database 111. Alternatively, segments 301 may comprise URLs indicating the location from which content may be obtained by video playback device 103 via the Internet 107. In one or more embodiments, the content of one or more segments 301 may be provided by RSS feeds, generated by sources outside the system of the invention. In one or more embodiments, the individual video, image, or text files referenced therein may be obtained by server computer system 109 and stored in database 111 to facilitate retrieval by video playback devices 103. In one or more embodiments, the data associated with each segment 301 in database 111 may include metadata, such as the segment's name, size, duration, tags or keywords to facilitate searching, and other such metadata commonly associated with digital video. In one or more embodiments, the video data of one or more segments 301 may be transcoded transcoded by server computer system 109 and/or database 111 into different video formats as needed for compatibility or storage requirements.

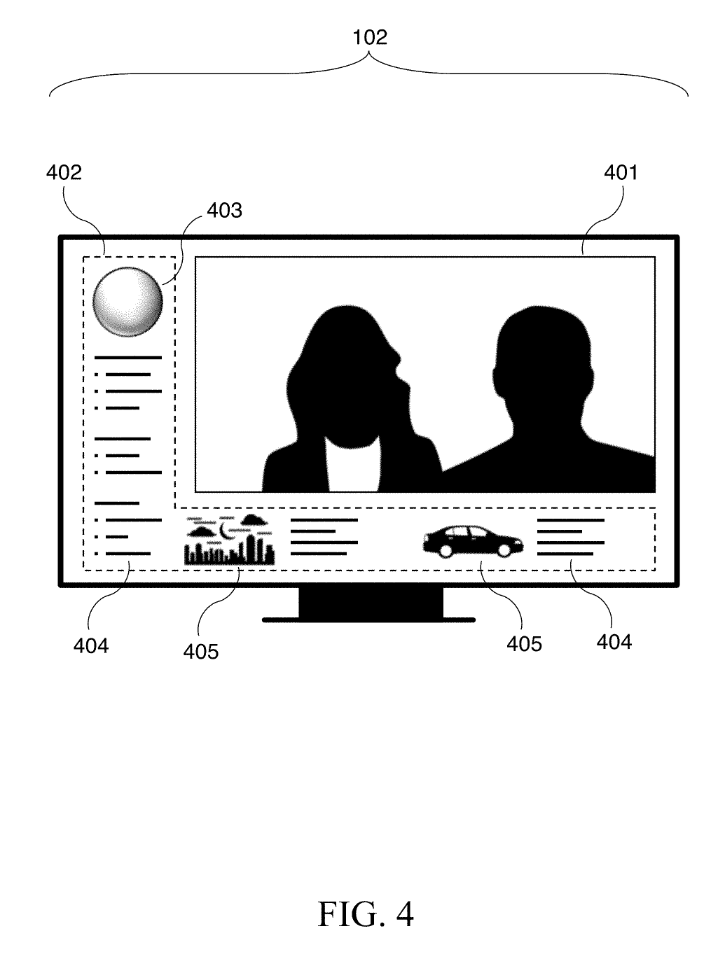

FIG. 4 shows the layout and positioning of content on a display 102 according to an embodiment of the present invention. In the embodiment of FIG. 4, a current segment of a program being played by video playback device 103 as the current “main program” 401 is displayed in a main program display area or window 401 in the upper right area of display 102 and is surrounded on the left and bottom edges by L-shaped sidebar 402 that displays television network logo 403, text 404, and/or additional video content or pictures 405. In one or more embodiments, text 404 and video or pictures 405 may include information such as a list of upcoming segments and/or programs on the channel being viewed or on other channels that are available, a news feed, information or content related to the currently playing main program, or other such information. In one or more embodiments, sidebar 402 may be divided into sub-regions which each display separate text 404 and video or pictures 405.

In one or more embodiments, server computer system 109 is configured to transfer metadata to video playback devices 103 and/or mobile devices 201. The metadata may include information identifying particular segments 301 and/or sequences 302 and 303, along with a time and date that each such segment 301 and/or sequence 302 or 303 should be played in main program window 401 (a “schedule”), as well as information identifying the position and content of text 404 and video or pictures 405 and the time to display such sidebar content. In one or more embodiments, video playback device 103 plays programs in main program window 401 and sidebar content in sidebar 402 according to the schedule. In one or more embodiments, server computer system 109 may be configured to transfer metadata to video playback devices 103 and/or mobile devices 201 that instructs the devices to ignore the schedule and immediately play another program in main program window 401 and/or sidebar content in sidebar 402.

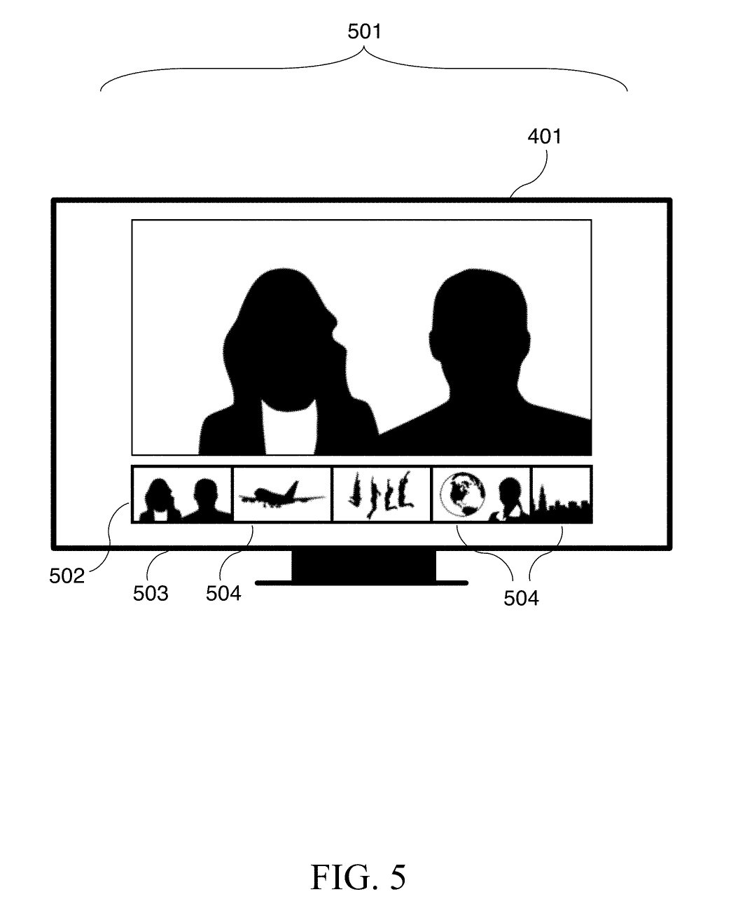

FIG. 5 shows the layout and positioning of content on a web page 501 according to an embodiment of the present invention. In one or more embodiments, web page 501 may be displayed in the web browser of a mobile device 201, such as a laptop computer 204. In the embodiment of FIG. 5, a segment that forms part of a main program is displayed on screen in main program window 401 and a list of segments 502 is displayed alongside main program window 401 (for example, as thumbnail images). In the embodiment of FIG. 5, the first segment 503 corresponds to the segment currently playing in main program window 401. Alternate segments 504 are displayed to the right of segment 503 so that a user may select a different segment 504 to display in main program window 401. In one or more embodiments, certain “hidden” segments may not appear in the list of segments 502 for selection by the user even though they play as part of the sequence. For example, interstitial “bumpers” announcing the name of the television network and/or the names of upcoming programs, as well as advertisement segments, may be hidden so that only a list of featured television programs appears as list 502.

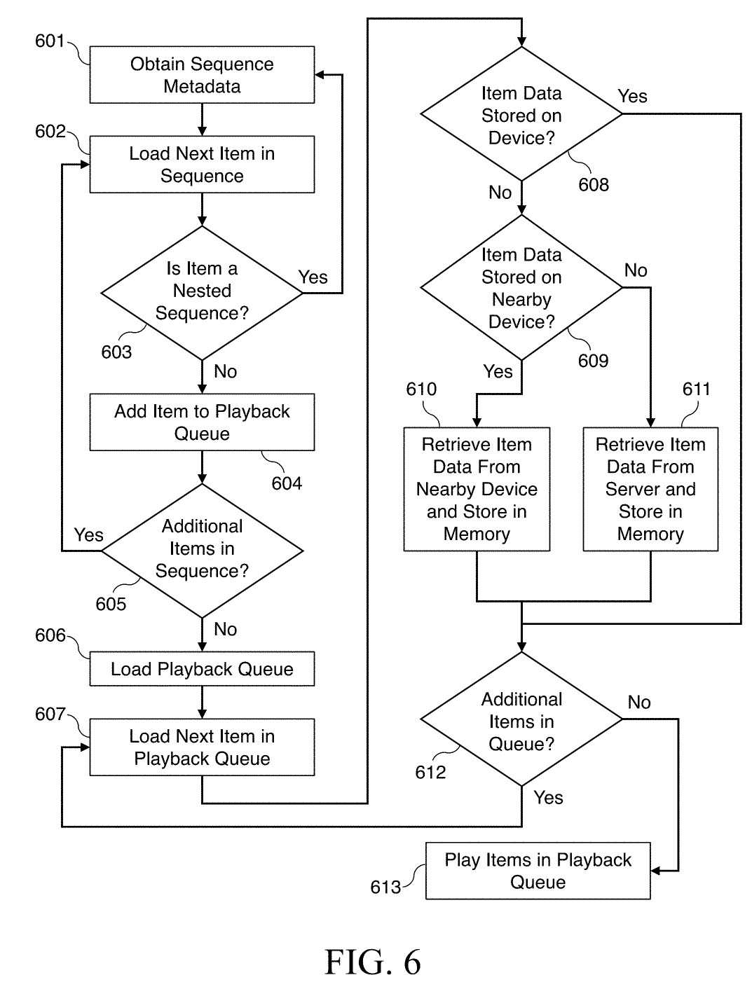

FIG. 6 is a flow chart illustrating the method steps performed by a video playback device 103 to load and play back a sequence 302 on a display 102 according to an embodiment of the present invention. The method begins at step 601. At step 601, video playback device 103 obtains metadata that defines sequence 302 from server computer system 109 and/or database 111. From step 601, the method continues to step 602. At step 602, video playback device 103 loads the next item in sequence 302, which includes retrieving any additional metadata associated with the item from server computer system 109 and/or database 111.

From step 602, the method continues to step 603. At step 603, video playback device 103 determines whether the item is a nested sequence. If so, the method returns to step 601 where video playback device 103 loads the metadata associated with the nested sequence to process the nested sequence. If the item is not a nested sequence, the method continues to step 604. At step 604, video playback device 103 adds the item to a playback queue for playback after completing the sequence processing steps.

From step 604, the method continues to step 605. At step 605, video playback device 103 determines whether there are additional unprocessed items remaining in sequence 302. If so, the method returns to step 602. If there are no unprocessed items remaining in sequence 302, the method continues to step 606.

At step 606, video playback device 103 loads the playback queue to process the items in the queue before playback. From step 606, the method continues to step 607. At step 607, video playback device 103 loads the next item in the playback queue. From step 607, the method continues to step 608. At step 608, video playback device 103 determines whether the video data for the item is stored in the device's memory. If so, the method continues to step 612.

If the video data for the item is not stored in the device's memory, the method continues to step 609. At step 609, video playback device 103 determines whether the video data for the item is stored in a nearby device's memory. If so, the method continues to step 610. If not, the method continues to step 611.

At step 610, video playback device 103 retrieves the video data for the item from the nearby device and stores the video data in memory. At step 612, video playback device 103 retrieves the video data for the item from the server computer system 109 and/or database 111 and stores the video data in memory. From both steps 610 and 611, the method continues to step 612. At step 612, video playback device 103 determines if there are additional unprocessed items remaining in the queue. If so, the method returns to step 607. If there are no unprocessed items remaining in the queue, the method continues to step 613. At step 613, video playback device 103 plays the items in the playback queue.

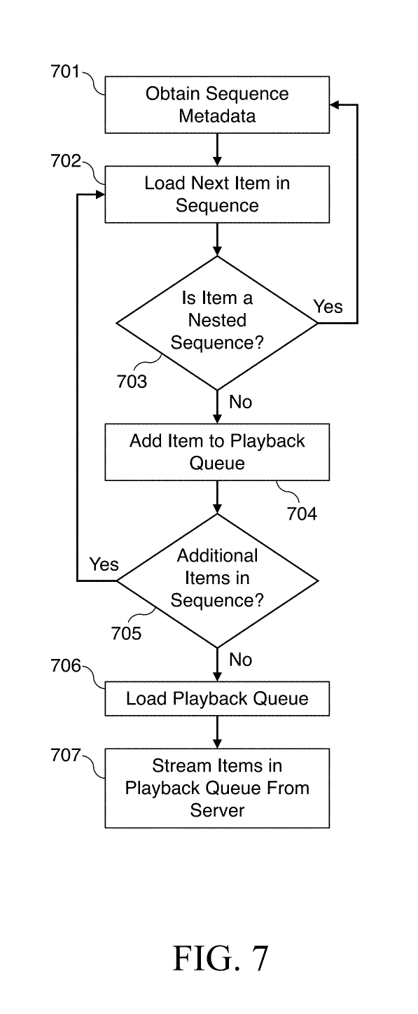

FIG. 7 is a flow chart illustrating the method steps to load and play back a sequence 302 on a web page 501 performed by computer readable instructions executing on server computer system 109 and/or mobile device 201 according to an embodiment of the present invention. The method begins at step 701. At step 701, the method obtains metadata that defines sequence 302 from server computer system 109 and/or database 111. From step 701, the method continues to step 702. At step 702, the method loads the next item in sequence 302, which includes retrieving any additional metadata associated with the item from server computer system 109 and/or database 111.

From step 702, the method continues to step 703. At step 703, the method determines whether the item is a nested sequence. If so, the method returns to step 701 where the method loads the metadata associated with the nested sequence to process the nested sequence. If the item is not a nested sequence, the method continues to step 704. At step 704, the method adds the item to a playback queue for playback after completing the sequence processing steps.

From step 704, the method continues to step 705. At step 705, the method determines whether there are additional unprocessed items remaining in sequence 302. If so, the method returns to step 702. If there are no unprocessed items remaining in sequence 302, the method continues to step 706.

At step 706, the method loads the playback queue. From step 706, the method continues to step 707. At step 707, the method streams the items in the playback queue from server computer system 109 and/or database 111 and plays the items on web page 501.

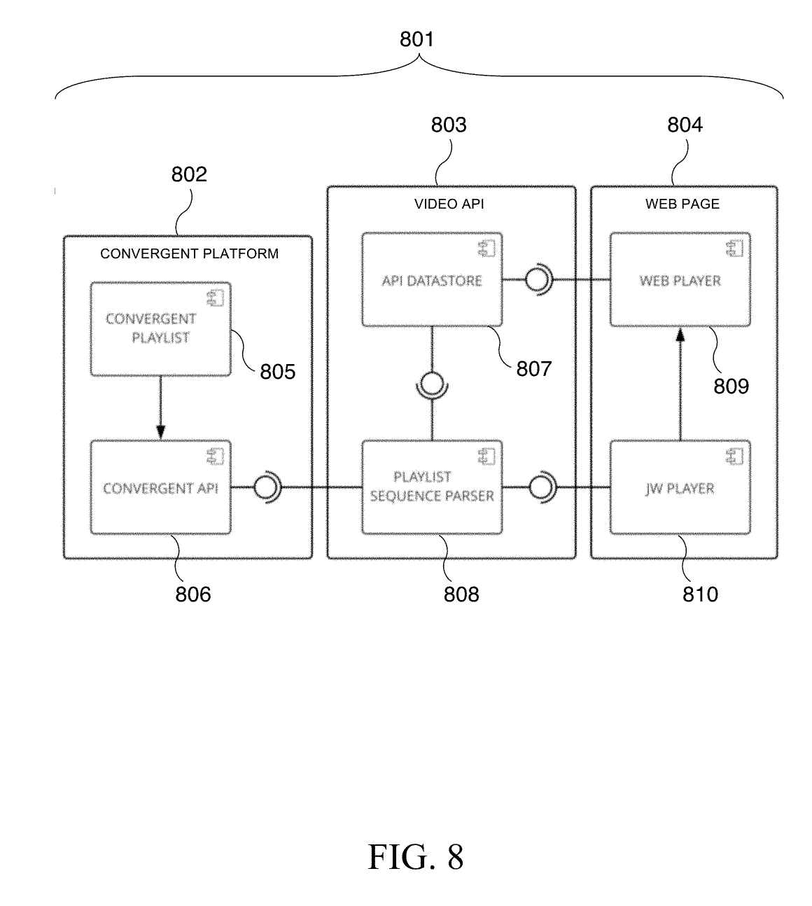

FIG. 8 is a block diagram of the components 801 used to display digital video content on a web page according to an embodiment of the present invention. In the embodiment of FIG. 8, components 801 include Convergent platform 802, video API 803, and web page 804. In the embodiment of FIG. 8, Convergent platform 802 is a commercially-available digital signage platform provided by Convergent Media Systems Corporation. In one or more embodiments, Convergent platform 802 is implemented in part using certain commercially-available software, such as the Stacks digital signage platform software provided by TargetR Ltd. Further information regarding Convergent and Stacks can be found at https://www.convergent.com/, https://stacks.targetr.net/assets/help/index.html, and http://www.targetr.net/, all of which are incorporated herein by reference. In the embodiment of FIG. 8, video API 803 and web page 804 are implemented in part using custom software that provides the functionality described herein which is not provided by Convergent platform 802, Stacks, or any other commercially-available software.

In the embodiment of FIG. 8, Convergent platform 802 comprises Convergent playlist 805 and Convergent API 806. In the embodiment of FIG. 8, Convergent playlist 805 is a media datastore configured to store the video data of segments 301, as well as playlist metadata including the hierarchical segment and sequence information described above with respect to FIG. 3. Convergent playlist 805 may be stored on a database hosted by Convergent Media Systems Corporation, on server computer system 109 and/or database 111, or alternatively on a separate computer system or systems, such as a “cloud” server. Convergent API 806 provides an application programming interface (API) to access the video data and playlist metadata stored in Convergent playlist 805. In the embodiment of FIG. 8, Convergent API 806 is a web-based API that is configured to use the JavaScript Object Notation (JSON) format to transfer data objects between Convergent platform 802 and other software that uses the API. However, in one or more embodiments, Convergent API 806 may be configured to use any data format now known or later invented to transfer data objects. In the embodiment of FIG. 8, Convergent playlist 805 and Convergent API 806 are implemented in software running on server computer system 109 and/or database 111.

In the embodiment of FIG. 8, Convergent platform 802 stores video playlists as a sequence of programming “slots”, each of which may contain either an individual video item or a another playlist as a nested sub-sequence of items or sequences. Also, Convergent platform 802 video playlists may be derived from a “master” sequence, which serves as a template with some or all slots already populated with items. A video playlist derived from a master sequence may override some or all slots with different items. However, in the embodiment of FIG. 8, Convergent API 806 has the limitation that playlists which are based on a master sequence, or which contain one or more sub-sequences, are provided by the API as sequences where only the top-level individual video items are wholly contained in the returned data object. Any individual video items derived from the master sequence, as well as any sub-sequences, are returned as pointers to data objects which must be separately retrieved from the API. Thus, in the embodiment of FIG. 8, Convergent API 806 does not provide a method for obtaining a data object containing a “flat” sequence of all individual video items in a playlist, which is the format required by web player 809 and web video content player framework 810 to display video content on web page 804.

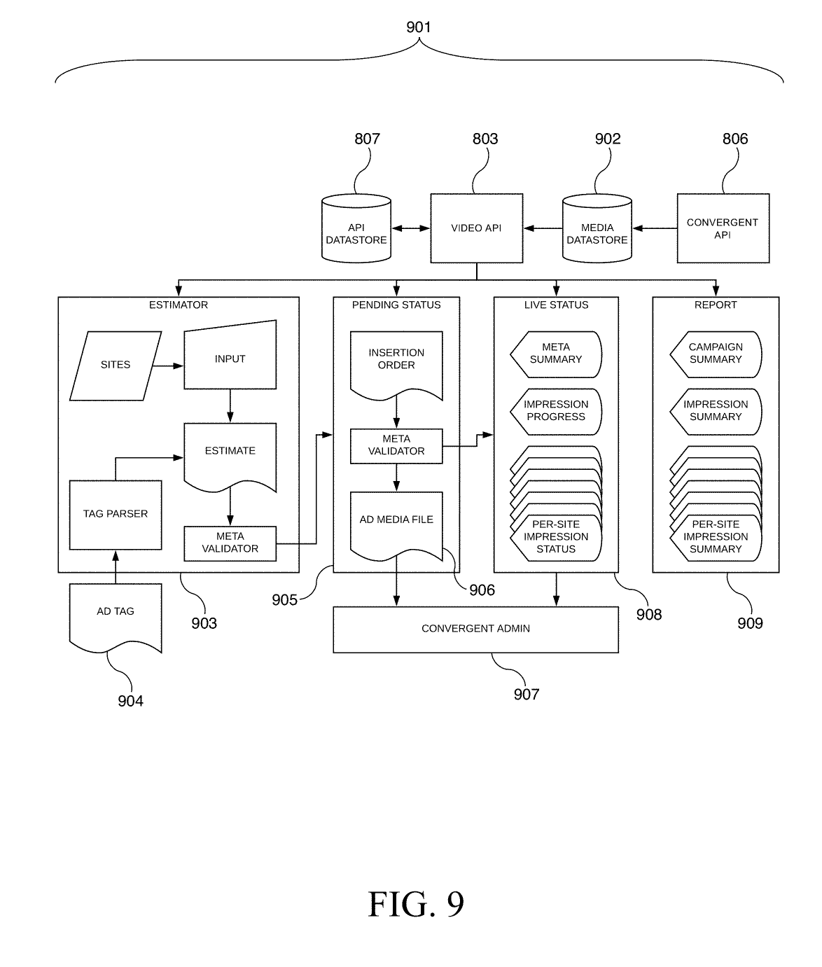

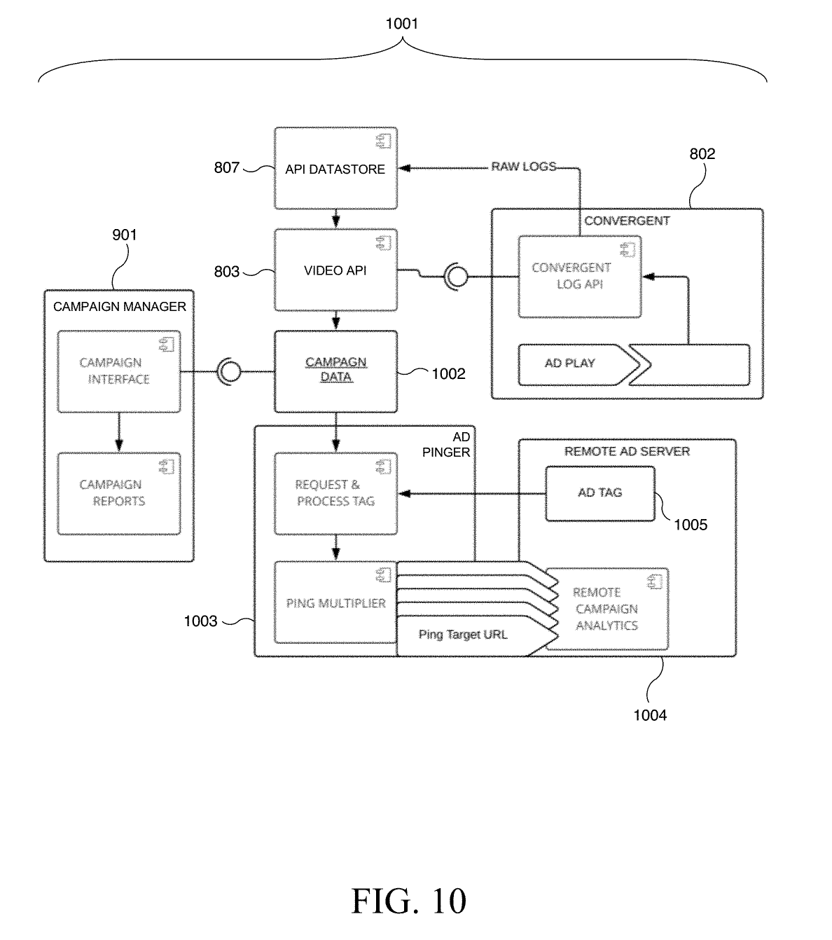

In the embodiment of FIG. 8, video API 803 comprises API datastore 807 and playlist sequence parser 808. API datastore 807 stores additional data and metadata specific to system 101 which is not provided by Convergent platform 802, such as data to facilitate the tracking, reporting, and analytics functionality described below with respect to FIGS. 9 and 10. Playlist sequence parser 808 connects to API datastore 807 and Convergent API 806 and performs the method steps described above with respect to FIG. 7 to produce a “flat” playlist and video data in the format required by the video playback functionality of web page 804.

In the embodiment of FIG. 8, web page 804 comprises web player 809 and web video content player framework 810. In the embodiment of FIG. 8, web video content player framework 810 is a commercially-available web video content player, such as JW Player. Web player 809 provides the user interface comprising main program window 401 and list of segments 502 as described above with respect to FIG. 5. In the embodiment of FIG. 8, web player 809 is configured to display content using web video content player framework 810, which connects to playlist sequence parser 808 and plays the video content items provided by playlist sequence parser 808. In the embodiment of FIG. 8, web player 809 connects to API datastore 807 and retrieves the segment and sequence information required to display list of segments 502. In one or more embodiments, web player 809 may be configured to display content in the manner described above with respect to FIGS. 4 and 5.

In one or more embodiments, the method of the present invention includes the creation, display, and tracking of advertising segments. An advertising segment may be digital video content, pictures, text, or a combination thereof. Advertising segments may be included in a sequence, optionally along with other types of segments and/or sequences. In one or more embodiments, the method of the present invention includes models for computing or estimating the number of viewers who are likely to have seen an advertising segment (i.e., the number of impressions). For example, in an airport, the number of passengers arriving and departing at particular times is known, and may be used as a heuristic to estimate the number of passengers who may have viewed the advertising segment on a display at the airport.

FIG. 9 is a block diagram of an advertisement campaign manager 901 used to select, display, and estimate impressions of advertisement campaigns according to an embodiment of the present invention. In the embodiment of FIG. 9, video API 803, Convergent API 806, and API datastore 807 are as described above with respect to FIG. 8. Media datastore 902 is a component of Convergent platform 802 and is configured to store impression metadata relating to one or more campaigns each comprising one or more advertising segments, including the number of times and the locations at which each campaign has been played. In the embodiment of FIG. 9, Convergent platform 802 is configured to keep logs relating to the playback of campaigns and media datastore 902 is configured to synchronize those logs and store them in media datastore 902 at regular intervals. In the embodiment of FIG. 9, video API 803 provides access to the playback log data stored in media datastore 902.

In the embodiment of FIG. 9, estimator 903 is configured to provide a web application interface to allow a user to create advertisement campaign estimates based on known data, such as the monthly passenger arrival and departure figures for an airport, or the amount of foot traffic in a plaza. In the embodiment of FIG. 9, each campaign has an associated ad tag 904 that stores metadata relating to the campaign, which is used by estimator 903 to fine-tune the estimated impression figures for that campaign. Such metadata may include, for example, information about the demographic to which the campaign is targeted, or the geographical area in which the campaign is relevant. In the embodiment of FIG. 9, estimator 903 includes a tag parser configured to process ad tag 904 and provide the metadata therein to the estimation logic of estimator 903. In the embodiment of FIG. 9, estimator 903 also has a meta validator, which prevents the assignment of the advertisement campaign to pending status 905 until all data required by estimator 903 has been input and validated.

In the embodiment of FIG. 9, once all data required by estimator 903 has been input and validated, the advertisement campaign is assigned to pending status 905. A campaign in pending status 905 is associated with an insertion order, which specifies where and how often the campaign should appear in Convergent playlist 805. In one or more embodiments, the campaign is also associated with start and end dates, which specify the date interval during which the campaign should be displayed. In the embodiment of FIG. 9, ad media file 906, which contains the video data for the one or more advertising segments in the campaign, is provided to Convergent administrative interface 907, a component of Convergent platform 802, for insertion into Convergent playlist 805.

In the embodiment of FIG. 9, the advertisement campaign is assigned to live status 908 once the start date for the campaign is reached. In one or more embodiments, video API 803 is configured to provide overall impression progress data relating to current campaign performance from media datastore 902, as well as live per-site impression status reports, which allow the user to fine-tune campaign metadata to reach the desired level of campaign impressions. In the embodiment of FIG. 9, the user may manually adjust campaign metadata via Convergent administrative interface 907.

In the embodiment of FIG. 9, once the end date for the campaign is reached, a snapshot of the campaign metadata, including overall impression progress data and a per-site impression summary, is stored as a report 909 for future reference.

In one or more embodiments, the method of the present invention includes the translation of advertising segment tracking data into formats used and/or required by advertisers. For example, web-based video advertising typically tracks viewership by recording the number of times the advertisement is retrieved and played via a particular URL. In one or more embodiments, the method of the present invention first computes the number of views of the advertisement as described above, and subsequently retrieves the advertisement's URL multiple times, once for each computed view.

FIG. 10 is a block diagram of an advertisement campaign reporter 1001 used to track and report estimated viewership of advertisements according to an embodiment of the present invention. In the embodiment of FIG. 10, API datastore 807 is configured to retrieve campaign playback logs from Convergent platform 802 and store them in API datastore 807 at regular, frequent intervals. In the embodiment of FIG. 10, video API 803 is configured to retrieve campaign playback logs from API datastore 807 and from Convergent platform 802 at regular, less frequent intervals and produce summary media item play reports for the campaign which are provided as campaign data 1002 to ad pinger 1003.

In the embodiment of FIG. 10, ad pinger 1003 uses campaign data 1002 to report estimated or computed advertisement impressions to remote ad server 1004 by repeatedly retrieving advertisement data from ad server 1004 to simulate the estimated or computed number of impressions, which ad server 1004 cannot directly track. In the embodiment of FIG. 10, ad pinger 1003 requests the campaign ad tag 1005 each time it attempts to report advertisement impressions to ensure ad pinger 1003 has the current ad tag metadata values and ping target URLs for the advertisement campaign. Ad pinger 1003 then passes campaign data 1002 and ad tag 1005 metadata to a ping multiplier, which uses campaign data 1002 to calculate the number of impressions to simulate. In the embodiment of FIG. 10, the ping multiplier then performs the calculated number of advertisement data retrievals from remote ad server 1004. In one or more embodiments, the ping multiplier uses further multiplier metadata to fine-tune advertisement impression rates for each different site. In one or more embodiments, aggregated data for each ping multiplier session is stored alongside the campaign metadata for later reporting and analysis.

Thus, broadcasting network systems for broadcasting digital video content to multiple displays or devices over a network, caching digital video content on those displays or devices, controlling the program scheduling on those displays or devices, remotely administering the displays or devices over the network, and methods for using the same are described. Although the present invention has been described with respect to certain specific embodiments, it will be clear to those skilled in the art that the inventive features of the present invention are applicable to other embodiments as well, all of which are intended to fall within the scope of the present invention.

1. (canceled)

2. A video playback device for receiving digital video content from a system for broadcasting digital video content to a plurality of the video playback devices over a computer network, the video playback device comprising:
a first connection to the computer network;
a second connection to at least one video display;
wherein the video playback device is configured to receive the digital video content and associated playback instructions from a server computer system database via the computer network and to play the digital video content on the at least one video display according to the playback instructions.

3. The video playback device of claim 2 wherein the digital video content comprises a video sequence comprising one or more video segments and wherein the playback instructions comprise a time and date that the video sequence should be played.

4. The video playback device of claim 3 wherein one or more of the video segments is an advertising segment.

5. The video display device of claim 2 wherein the playback instructions comprise instructions specifying the position where the digital video content should be displayed on the at least one video display connected to the video playback device.

6. The video display device of claim 2 further comprising a memory and being further configured to store the digital video content and the playback instructions in the memory for playback at a later time.

7. The video display device of claim 6 further configured to transfer the digital video content and the playback instructions stored in the memory to a second video playback device.

8. The video display device of claim 6 wherein the second video playback device comprises a mobile device comprising an integrated display.

9. The video display device of claim 4 further configured to store a date and time of the playback of each advertising segment in an advertising segment playback log.

10. The video display device of claim 1 further configured to transmit the advertisement playback log an estimator, wherein the estimator is configured to process the advertising segment playback log to produce an estimated number of impressions for the advertising segment.

11. The video display device of claim 1 comprising a mobile device with an integrated display.

12. A broadcasting computer system for broadcasting digital video content to a plurality of video display devices via a computer network, the broadcasting computer system comprising a database comprising digital video content and metadata comprising playback instructions, the broadcasting computer system being configured to transfer the digital video content and the playback instructions from the database to the video playback devices via the computer network.

13. The broadcasting computer system of claim 12 wherein the digital video content comprises a video sequence comprising one or more video segments and wherein the playback instructions comprise a time and date that the video sequence should be played.

14. The broadcasting computer system of claim 13 wherein one or more of the video segments is an advertising segment.

15. The broadcasting computer system of claim 12 wherein the playback instructions comprise instructions specifying the position where the digital video content should be displayed on display screens connected to one or more of the plurality of video display devices.

16. The broadcasting computer system of claim 12 wherein the database further comprises advertisement campaign metadata and an advertisement playback log comprising the date and time of the playback of each advertising segment.

17. The broadcasting computer system of claim 16 wherein the broadcasting computer system is further configured to process the advertisement campaign metadata and the advertising segment playback log to produce an estimated number of impressions for the advertising segment.

18. The broadcasting computer system of claim 17 further configured to retrieve advertisement data from an advertisement server according to the estimated number of impressions for the advertising segment.

19. A system for broadcasting digital video content via a computer network comprising:
a plurality of video playback devices, each of the video playback devices comprising a first connection to the computer network and a second connection to at least one video display;
a broadcasting computer system for broadcasting digital video content to a the plurality of video display devices via the computer network, the broadcasting computer system comprising a database comprising digital video content and metadata comprising playback instructions, the broadcasting computer system being configured to transfer the digital video content and the playback instructions from the database to the video playback devices via the computer network;
wherein each of said video playback device is configured to receive the digital video content and associated playback instructions from the broadcasting computer system via the computer network and to play the digital video content on at least one video display according to the playback instructions.

20. The system for broadcasting digital video content of claim 19 wherein the plurality of video playback devices comprise at least one mobile device comprising an integrated video display.

21. The system for broadcasting digital video content of claim 20 wherein the database further comprises advertisement campaign metadata and an advertisement playback log comprising the date and time of the playback of each advertising segment.
